(19) United States
(12) Patent Application Publication
(10) Pub. No.: US 2023/0420957 A1
(43) Pub. Date: Dec. 28, 2023

(54) BATTERY STRING CONFIGURATION

(71) Applicant: FORM ENERGY, INC., Somerville, MA (US)

(72) Inventors: Tyler GRANDAHL, Carlisle, MA (US); Amelie Nina KHAREY, Cambridge, MA (US); Nicholas MCKIBBEN, Oakland, CA (US); Keith William JOHNSTON, Calgary (CA)

(21) Appl. No.: 18/305,941

(22) Filed: Apr. 24, 2023

Related U.S. Application Data
(60) Provisional application No. 63/334,054, filed on Apr. 22, 2022.

(51) Int. Cl. H02J 7/00; H01M 50/204; H01M 12/08; H01M 50/51; H01M 10/46

(52) U.S. Cl. CPC H02J 7/0024; H01M 50/204; H01M 12/08; H01M 50/51; H01M 10/46

(57) ABSTRACT

Systems, methods, and devices of the various embodiments may include battery string arrangements for power systems, such as dynamic battery string configurations, inter-module connections, and other configurations.

### CROSS-REFERENCE TO RELATED APPLICATIONS

This application claims the benefit of priority to U.S. Provisional Patent Application 63/334,054, filed Apr. 22, 2022, the entire contents of which are hereby incorporated herein by reference.

### BACKGROUND

Energy storage technologies are playing an increasingly important role in electric power grids. These energy storage assets provide smoothing for better matching generation and demand on a grid. The services performed by energy storage devices are beneficial to electric power grids across multiple time scales, from milliseconds to years. Today, energy storage technologies exist that can support timescales from milliseconds to hours, but there is a need for increased availability, reliability, and resiliency with reduced costs in energy storage systems.

### SUMMARY

Systems, methods, and devices of the various embodiments may include battery string configurations for power systems, such as dynamic battery string configurations, inter-module connections, etc.

Various embodiments may include a battery system, comprising: two or more strings of batteries; and an electrical power conversion system connected to the strings of batteries and controllable to change configuration of connections of a set of switches to the two or more strings based on the operating state of the battery system. In various embodiments, each of the strings of batteries comprise battery cells connected in series. In various embodiments, the battery cells comprise metal-air type battery cells. In various embodiments, the battery cells comprise iron-air type battery cells, zinc-air type battery cells, and/or lithium-air battery cells. In various embodiments, the battery cells are connected in series to have: a maximum operational voltage in a charge operating state less than a DC voltage maximum; and a maximum operational voltage in a discharge operating state less than the DC voltage maximum. In various embodiments, the DC voltage maximum is 1500 V. In various embodiments, the two or more strings of batteries comprise at least a four string grouping; in the charge state: in a first charging configuration the electrical power conversion system connects two power conversion stages independently to two strings of batteries of the four string grouping and controls the two power conversion stages to operate in lock-step at identical or unique DC currents to charge the two strings of batteries of the four string grouping; and in a second charging configuration the electrical power conversion system connects the two power conversion stages independently to the other two strings of batteries of the four string grouping and controls the two power conversion stages to operate in lock-step at identical or unique DC currents to charge the other two strings of batteries of the four string grouping; and in the discharge state: a first set of two strings of batteries of the four string grouping is connected in series; a second set of the two strings of batteries of the four string grouping is connected in series; and the electrical power conversion system connects one of the two power conversion stages to the first set of two strings and the second of the two power conversion stages to the second set of two strings.

Various embodiments may include a battery system, comprising: subsets of serially connected substrings of battery modules, wherein the subsets are configured to be connected into a full string; and a bypass switch associated with each subset configured to enable each subset to be individually switched in and out of the full string.

Various embodiments may include a battery system, comprising: a series of battery modules connected via skip stringing.

### DESCRIPTION OF THE DRAWINGS

FIG. 1 is a block diagram of a power generation system in communication with a plant management system, the power generation system including a power generation source, a LODES, an SDES, a power controller, a plant controller, a transmission facility, and a power grid.

FIG. 2 is a block diagram of a power generation system in communication with a plant management system, the power generation system including a plurality of power plants.

FIG. 3 is a schematic representation of a battery including a vessel, an air electrode, a negative electrode, a liquid electrolyte, and a current collector.

FIG. 4 is a graph of current and voltage of an iron-air battery full cycle profile.

FIG. 5A is a schematic representation of strings of batteries connected to power conversion equipment, with the strings of batteries shown connected to the power conversion equipment in a direct state.

FIG. 5B is a schematic representation of the strings of batteries and the power conversion equipment of FIG. 4A, with the strings of batteries shown connected to the power conversion equipment in a voltage doubling state.

FIG. 6A is a schematic representation of strings of batteries arranged with central power conversion to direct power within a block.

FIG. 6B is a schematic representation of strings of batteries arranged with distributed power conversion to direct power within a block.

FIG. 7A is a schematic representation of a first baseline configuration of a battery system including strings of batteries with a centralized AC/DC inverter and DC/DC converters for each string of batteries, with the battery system operating in symmetric power (SP) mode.

FIG. 7B is a schematic representation of the first baseline configuration of the battery system of FIG. 7A, with the battery system operating in symmetric typical current (STC).

FIG. 7C is a schematic representation of the first baseline configuration of the battery system of FIG. 7A, with the battery system operating in staggered symmetric typical current (SSTC).

FIG. 8 is a schematic representation of a second baseline configuration of a battery system including strings of batteries and AC/DC inverters for each string of batteries.

FIG. 9A is a schematic representation of a battery system including strings of batteries, AC/DC inverters for each string of batteries, and the battery system switchable between direct state (IS) and voltage doubling (2S) configurations, with the battery system shown in discharge mode.

FIG. 9B is a schematic representation of the battery system of FIG. 9A, with the battery system shown in a first charge mode.

FIG. 9C is a schematic representation of the battery system of FIG. 9A, with the battery system shown in a second charge mode.

FIG. 10 is a schematic representation of a battery system including strings of batteries and a plurality of switches actuatable to reconfigure the battery strings between a discharge mode, a first charge mode, and a second charge mode.

FIG. 11 is a schematic representation of a battery system including substring DC/DC conversion in a string of batteries.

FIG. 12 is a schematic representation of a battery system including short-edge field unit electrical bypassing to minimize bypass state conduction path and loss.

FIG. 13 is a schematic representation of a battery system including skip-stringing of batteries together.

Like reference symbols in the various drawings indicate like elements.

### DETAILED DESCRIPTION

Embodiments will be described in detail with reference to the accompanying drawings, in which exemplary embodiments are shown. The foregoing may, however, be embodied in many different forms and should not be construed as limited to the exemplary embodiments set forth herein.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, the configurations provided in the various embodiments of this specification may be used with each other. For example, the components of an embodiment having A, A′ and B and the components of an embodiment having A″, C and D can be used with each other in various combinations, e.g., A, C, D, and A. A″ C and D, etc., in accordance with the teaching of this Specification.

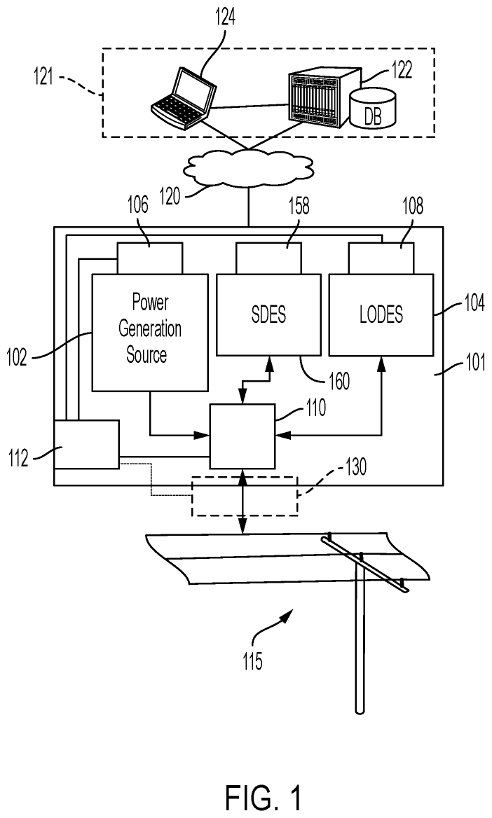

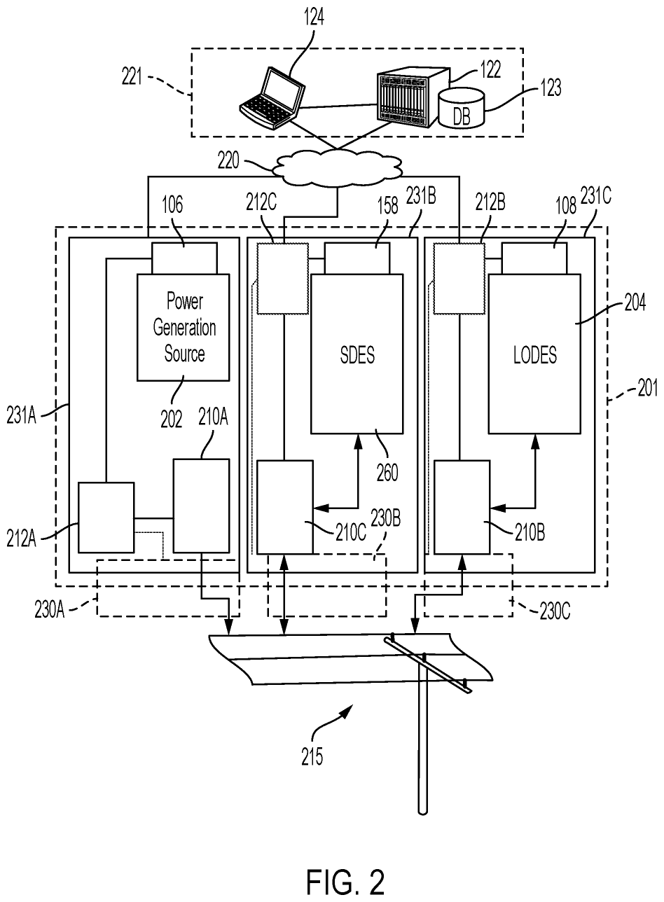

For the sake of clear and efficient description, elements with numbers having the same last two digits in the disclosure that follows shall be understood to be analogous to or interchangeable with one another, unless otherwise specified or made clear from the context, and, therefore, are not described separately from one another, except to note differences and/or to emphasize certain features. For example, in the description that follows, the power generation system 101 (FIG. 1) shall be understood to be analogous to and/or interchangeable with the power generation system 201 (FIG. 2), unless a contrary intent is expressed or made clear from the context.

The present disclosure is directed to systems, methods, and devices for electrochemical energy storage systems, such as metal-air battery systems. Various embodiments may be applicable to power conversion in energy storage systems in which there may be a wide DC voltage swing across multiple operating states. As an example, various embodiments may be applicable to battery systems, such as metal-air battery systems, in which there may be a wide DC voltage operating range in a charge operating state versus a discharge operating state.

Various embodiments may provide devices and/or methods for use in long-duration, and ultra-long-duration, low-cost, energy storage. Herein, “long duration” and “ultra-long duration” and similar such terms, unless expressly stated otherwise, shall be understood to include periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. and may include long duration energy storage (LODES) systems. Further, the terms “long duration” and “ultra-long duration”, “energy storage cells” including “electrochemical cells”, and similar such terms, unless expressly stated otherwise, shall include electrochemical cells that may store energy over time spans of days, weeks, or seasons. As used herein, unless a contrary intention is explicitly stated or made clear from the context, the term “duration” shall be understood to refer to a ratio of energy to power of an energy storage system. For example, a system with a rated energy of 24 MWh and a rated power of 8 MW has a duration of 3 hours, and a system with a rated energy of 24 MWh and a rated power of 1 MW has a duration of 24 hours. Physically, the duration may be interpreted as the run-time of the energy storage system at maximum power.

In general, a long duration energy storage cell may be a long duration electrochemical cell. Such a long duration electrochemical cell may store electricity generated from an electrical generation system, when: (i) the power source or fuel for the electrical generation system is available, abundant, inexpensive, or otherwise advantageous; (ii) the power requirements or electrical needs of the electrical grid, customer or other user, are less than the amount of electricity generated by the electrical generation system, the price paid for providing such power to the grid, customer or other user, is below an economically efficient point for the generation of such power (e.g., cost of generation exceeds market price for the electricity), and combinations and variations of these; and (iii) combinations and variations of (i) and (ii) as well as other reasons. The electricity stored in the long duration electrochemical cell may be distributed to the grid, customer or other user, at times when it is economical, otherwise advantageous and/or as needed. For example, the electrochemical cells may store energy generated by solar cells during the summer months, when sunshine is plentiful and solar power generation exceeds power grid requirements. Continuing with this example, the electrochemical cells may discharge the stored energy during the winter months, when sunshine may be insufficient for energy generated by the solar cells to satisfy power grid requirements.

Various embodiments may provide devices and/or methods for use in bulk energy storage systems, such as long duration energy storage (LODES) systems, short duration energy storage (SDES) systems, etc. As an example, various embodiments may include configurations and controls for batteries of bulk energy storage systems, such as batteries for LODES systems.

While various examples are discussed with reference to Li-ion and/or Fe-air, the discussion of Li-ion and/or Fe-air is used merely as an example and various embodiments. Unless otherwise specified or made clear from the context, other combinations and permutations of storage technologies may be substituted for the example solar+Li-ion+Fe-air discussed herein. For example, various metal-air storage technologies may be used as batteries in the various embodiments, such as zinc-air, lithium-air, sodium-air, etc.

U.S. Pat. App. Pub. 2021/0028457, entitled “LOW COST METAL ELECTRODES,” which published on Jan. 28, 2021, the entire contents of which are hereby incorporated herein by reference, describes various aspects of electrochemical cells, such as rechargeable batteries using metal electrodes (e.g., iron negative electrodes), and design, manufacture, and processing features of electrochemical cells, such as rechargeable batteries using iron metal electrodes (e.g., iron negative electrodes), with which various embodiments described herein may be used and into which various embodiments described herein may be incorporated. Additionally, U.S. Pat. App. Pub. 2021/0028457 provides examples of metal materials (e.g., iron materials) with which various embodiments described herein may be used. Further, U.S. Pat. App. Pub. 2021/0028457 describes bulk energy storage systems, such as LODES systems, with which various embodiments described herein may be used and into which various embodiments as described herein may be incorporated.

As used herein, a “module” may include a string of unit electrochemical cells (e.g., a string of batteries). Multiple modules (or multiple units or electrochemical cells) may be electrically connected together to form battery strings.

Referring now to FIG. 1, a power generation system 101 may include a power generation source 102, a LODES 104, and an SDES 160. As examples, the power generation sources 102 may include renewable power generation sources, non-renewable power generation sources, combinations of renewable and non-renewable power generation sources, etc. Examples of the power generation source 102 may include any one or more of wind-powered generators, solar-powered generators, geothermal-powered generators, nuclear-powered generators, etc. As an example, the LODES 104 may include one or more electrochemical cells (e.g., one or more batteries). The batteries may be any type of battery, such as rechargeable secondary batteries, refuelable primary batteries, combinations of primary and secondary batteries, etc. Battery chemistries may be any battery chemistry, such as Al, AlCl₃, Fe, FeOₓ(OH)_{y}, NaₓS_{y}, SiOₓ(OH)_{y}, AlOₓ(OH)_{y}, metal-air, and/or any type of battery chemistry suitable for a particular implementation. The SDES 160 may include one or more electrochemical cells (e.g., one or more batteries). The batteries may be any type of battery, such as rechargeable secondary batteries, refuelable primary batteries, combinations of primary and secondary batteries, etc. Battery chemistries may be any battery chemistry, such as Li-ion, Na-ion, NiMH, Mg-ion, and/or any suitable type of battery chemistry suitable for a particular implementation.

In various embodiments, the power generation system 101 may include a first control system 106 for controlling operation of the power generation source 102. The first control system 106 may include motors, pumps, fans, switches, relays, or any other type devices associated with controlling one or more aspects of electricity generation by the power generation source 102. In various embodiments, the power generation system 101 may additionally, or alternatively, include a second control system 108 for controlling operation of the one or more LODESs 104. The second control system 108 may include motors, pumps, fans, switches, relays, or any other type devices that may serve to control the discharge and/or storage of electricity by the LODES 104. In various embodiments, the power generation system 101 may further, or instead, include a third control system 158 for controlling operation of the SDES 160. The third control system 158 may include motors, pumps, fans, switches, relays, or any other type devices that may serve to control the discharge and/or storage of electricity by the SDES 160. The first control system 106, the second control system 108, and the third control system 158 may each be connected to a plant controller 112. The plant controller 112 may monitor the overall operation of the power generation system 101 and, for example, generate and send control signals to one or more of the first control system 106, the second control system 108, or the third control system 158 as necessary or useful to control the respective operations of the power generation source 102, the LODES 104, and/or the SDES 104.

The power generation source 102, the LODES 104, and the SDES 160 may each be connected to a power controller 110. The power controller 110 may be connected to a power grid 115 or other electrical transmission infrastructure. The power controller 110 may include, for example, switches, inverters (e.g., AC to DC inverters, DC to AC inverters, etc.), relays, power electronics, and any other type equipment that may facilitate controlling the flow of electricity to/from one or more of the power generation source 102, the LODES 104, the SDES 160, and/or the power grid 115. Additionally, or alternatively, the power generation system 101 may include a transmission facility 130 connecting the power generation system 101 in electrical communication with the power grid 115. As an example, the transmission facility 130 may selectively establish electrical communication between the power controller 110 and the power grid 115 such that electricity may flow between the power generation system 101 and the power grid 115. As an example, the transmission facility 130 may include one or more of transmission lines, distribution lines, power cables, switches, relays, transformers, and/or any other type of device that supports the flow of electricity in either direction between the power generation system 101 and the power grid 115.

The power controller 110 and/or the transmission facility 130 may be in electrical communication with the plant controller 112. The plant controller 112 may monitor and/or control one or more aspects of operation of the power controller 110 and/or the transmission facility 130. As examples, the plant controller 112 may control the power controller 110 and/or the transmission facility 130 to provide electricity from the power generation source 102 to the power grid 115, to provide electricity from the LODES 104 to the power grid 115, to provide electricity from both the power generation source 102 and the LODES 104 to the power grid 115, to provide electricity from the power generation source 102 to the LODES 104, to provide electricity from the power grid 115 to the LODES 104, to provide electricity from the SDES 160 to the power grid 115, to provide electricity from both the power generation source 102 and the SDES 160 to the power grid 115, to provide electricity from the power generation source 102 to the SDES 160, to provide electricity from the power grid 115 to the SDES 160, to provide electricity from the SDES 160 and the LODES 104 to the power grid 115, to provide electricity from the power generation source 102, the SDES 160, and the LODES 104 to the power grid 115, to provide electricity from the power generation source 102 to the SDES 160, to provide electricity from the power grid 115 to the SDES 160 and the LODES 104, etc. In various embodiments, the power generation source 102 may selectively charge the LODES 104 and/or SDES 160 and the LODES 104 and/or the SDES 160 may selectively discharge to the power grid 115. In this manner, energy (e.g., renewable energy, non-renewable energy, etc.) may be output to the power grid 115 some from the LODES 104 and/or SDES 160 at some time after the energy has been generated by the power generation source 102.

In various embodiments, the plant controller 112 may be in communication with a network 120 (e.g., 3G network, 4G network, 5G network, core network, Internet, combinations of the same, etc.). Using the connections to the network 120, the plant controller 112 may exchange data with the network 120 and with devices connected to the network 120, such as a plant management system 121 or any other device connected to the network 120. The plant management system 121 may include one or more computing devices, such as a computing device 124 and a server 122. The computing device 124 and the server 122 may be connected to one another directly and/or via connections to the network 120. The various connections network 120 by the plant controller 112 and the plant management system 121 (e.g., by the computing device 124 and/or the server of the plant management system 121) may be wired and/or wireless connections.

In various embodiments, the computing device 124 of the plant management system 121 may provide a user interface through which a user of the plant management system 121 may define inputs to the plant management system 121 and/or to the power generation system 101, receive indications associated with the plant management system 121 and/or with power generation system 101, or otherwise control operation of the plant management system 121 and/or of the power generation system 101.

While shown as two separate devices, 124 and 122, it shall be appreciated that this is for the sake of clear and efficient depiction and that the functionality of the computing device 124 and of the server 122 described herein may be combined into a single computing device or may split among more than two devices. Additionally, or alternatively, while shown as a dedicated part of the plant management system 121, it shall again be appreciated that this is for the sake of clear and efficient depiction and that the functionality of the computing device 124 and server 122 may be in whole, or in part, carried out by a remote computing device, such as a cloud based computing system. While shown as being in communication with a single instance of the power generation system 101, it shall be understood that the plant management system 121 may be in communication with multiple instances of the power generation system 101, unless otherwise specified or made clear from the context.

While shown as being co-located with one another in FIG. 1, any one or more of the power generation source 102, the LODES 104, and the SDES 160 may be separated from one another in various embodiments. For example, the LODES 104 may be downstream of a transmission constraint (e.g., downstream of a portion of the power grid 115, etc.) from the power generation source 102 and the SDES 160. In this manner, the over build of underutilized transmission infrastructure may be reduced, or avoided entirely, by situating the LODES 104 downstream of a transmission constraint, charging the LODES 104 at times of available capacity and discharging the LODES 104 at times of transmission shortage. The LODES 104 may also, or instead, arbitrage electricity according to prevailing market prices to reduce the final cost of electricity to consumers.

Referring now to FIG. 2, a power generation system 201 may include a power generation sources 202 and one or more bulk energy storage systems, such as a LODES 204 and/or an SDES 260, physically separated from one another. For example, the power generation source 202, the LODES 204 and the SDES 260 may be separated in different power plants 231A, 231B 231C, respectively. While the plants 231A, 231B, 231C may be physically separated from one another, the power generation system 201 and a plant management system 221 may operate as described above with reference to operation of the power generation system 101 and the plant management system 221 (FIG. 1). The power plants 231A, 231B, and 231C may be co-located or may be geographically separated from one another. The power plants 231A, 231B, and 231C may connect to a power grid 215 at different places. For example, the power plant 231A may be connected to the power grid 215 upstream of where the power plant 131B is connected to the power grid 215.

In some implementations, the power plant 231A associated with the power generation source 202 may include dedicated equipment for the control of the power plant 231A and/or for transmission of electricity to/from the power plant 231A. For example, the power plant 231A may include a plant controller 212A and a power controller 210A and/or a transmission facility 230A. The power controller 210A and/or the transmission facility 230A may be connected in electrical communication with the plant controller 212A. The plant controller 212A may, for example, monitor and control the operations of the power controller 210A and/or of the transmission facility 230A, such as via various control signals. As examples, the plant controller 212A may control the power controller 210A and/or the transmission facility 230A to provide electricity from the power generation 202 to the power grid 215, etc.

Additionally, or alternatively, the power plant 231B associated with the LODES 204 may include dedicated equipment for the control of the power plant 231B and/or for transmission of electricity to/from the power plant 231B. For example, the plant 231B associated with the LODESs 204 may include a plant controller 212B, a power controller 210B, and/or a transmission facility 230B. The power controller 210B and/or the transmission facilities 230B may be connected to the plant controller 212B. The plant controller 212B may monitor and control the operations of the power controller 210B and/or of the transmission facility 230B, such as via various control signals. As an example, the plant controller 212B may control the power controller 210B and/or the transmission facility 230B to provide electricity from the LODES 204 to the power grid 215 and/or to provide electricity from the power grid 215 to the LODES 204, etc.

Still further, or instead, the power plant 231C associated with the SDES 260 may include dedicated equipment for the control of the power plant 231C and/or for transmission of electricity to/from the power plant 231C. For example, the power plant 231C associated with the SDES 260 may include a plant controller 212C and a power controller 210C and/or a transmission facility 230C. The power controller 210C and/or the transmission facility 230C may be connected to the plant controller 212C. The plant controller 212C may monitor and control the operations of the power controller 210C and/or of the transmission facility 230C, such as via various control signals. As examples, the plant controller 212C may control the power controller 210C and/or the transmission facility 230C to provide electricity from the SDES 260 to the power grid 215 and/or to provide electricity from the power grid 215 to the SDES 260, etc.

In various embodiments, the respective plant controllers 212A, 212B, 212C may each be in communication with each other and/or with a network 220. Using the connections to the network 220, the respective plant controllers 212A, 212B, 212C may exchange data with the network 220 as well as with one or more devices connected to the network 220, such as the plant management system 221, each other, or any other device connected to the network 221. In various embodiments, the operation of the plant controllers 212A, 212B, 212C may be monitored by the plant management system 221 and the operation of the plant controllers 212A, 212B, 212C— and, thus, operation of the power generation system 201, may be controlled by the plant management system 221.

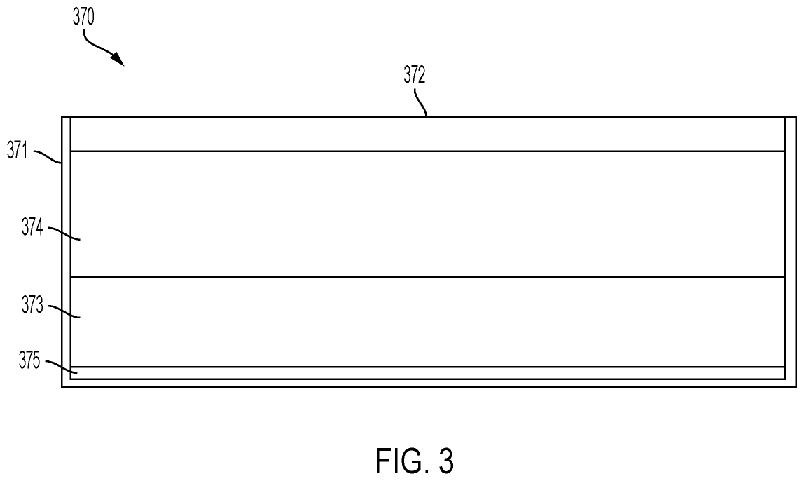

FIG. 3 is a schematic view of a battery 370 that may be used in the one or more LODES described herein (e.g., LODESs 104 in FIG. 1 and/or LODES 204 in FIG. 2). The battery 370 may be one type of battery that may be used in LODES of various embodiments described herein. The battery 370 may include a vessel 371, an air electrode 372, a negative electrode 373, a liquid electrolyte 3744, and a current collector 3756. The air electrode 272, the negative electrode 373, the liquid electrolyte 374, and the current collector 375 may each be disposed in the vessel 371. The negative electrode 373 may include a metal electrode (e.g., an iron electrode, a lithium electrode, a zinc electrode, or other type suitable metal). The liquid electrolyte 374 may separate the air electrode 372 from the negative electrode 373. Additionally, specific examples of batteries, such as batteries similar to the battery 370, that may be used in bulk energy storage systems, such as in LODES of the present disclosure are described in U.S. Pat. App. Pub. 2021/0028457, the entire contents of which are incorporated herein by reference. As examples, the battery 370 may be a metal-air type battery, such as an iron-air battery, a lithium-air battery, a zinc-air battery, etc. While various examples are described herein with reference to metal-air batteries, other types of batteries may be additionally, or alternatively, used in the various examples provided herein unless otherwise specified or made clear from the context. The battery 370 may be a single cell or unit, and multiple instances of the batteries 370—namely, multiple units or cells—may be connected together to form a module. Multiple modules may be connected to one another to form a battery string.

The configuration of the battery 371 is merely an example of one electrochemical cell configuration according to various embodiments and is not intended to be limiting. For example, while the battery 371 is shown as including a particular arrangement of the vessel 371, it shall be appreciated that other arrangements of the vessel 371 and omission of the vessel 371 are within the scope of the present disclosure. Other configurations, such as the battery 371 with different arrangements of the vessel 371 and/or without the vessel 371 shall be understood to be additionally, or alternatively, within the scope of the present disclosure unless a contrary intention is expressly indicated or made clear from the context. Further, or instead, the battery 370 may include different types of the air electrode 372 and/or may be without the air electrode 372 in implementations, which shall be understood to be within the scope of the present disclosure. Still further, or instead, the battery 370 may include different types of the current collector 375 and/or may be without the current collector 375 in implementations that shall be understood to be within the scope of the present disclosure. The battery 370 may additionally, or alternatively, include different types of the negative electrode 373 and/or may be without the negative electrode 373 according to implementations that shall be understood to be within the scope of the present disclosure. Additionally, or alternatively, the battery 370 with different types of the liquid electrolyte 374 and/or the battery 370 without the liquid electrolyte 204 shall be understood to be in accordance with the various embodiments in the present disclosure, unless otherwise specified or made clear from the context.

Having described aspects of power generation systems including power generation sources in electrical communication with battery-based energy storage (e.g., LODESs, SDESs, and combinations thereof), attention is now directed to dynamically controllable arrangements of batteries (also referred to herein as a battery system) for battery-based energy storage. Unless otherwise specified or made clear from the context, the battery systems described below shall be understood to relate to arrangements of a plurality of instances of any one or more of the batteries described herein and, more generally, shall be understood to be usable as battery-based energy storage for LODESs and/or SDESs in any one or more of the power generation systems described herein. For example, unless a contrary intent is indicated, the battery systems described below shall be understood to include a plurality of instances of the battery 370 (FIG. 3) for use in the LODES 104 and/or SDES 160 of the power generation system 101 (FIG. 1) and/or in the LODES 204 and/or SDES 260 of the power generation system 201 (FIG. 2).

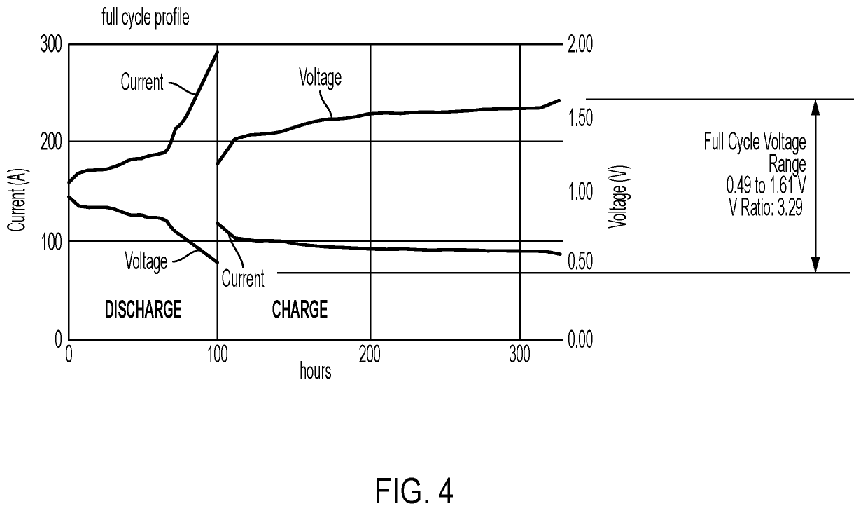

FIG. 4 is a graph of current and voltage of an iron-air battery full cycle profile. As may be appreciated from this full cycle profile, iron-air batteries—and metal-air battery chemistries more generally—operate over a wide voltage range between charge and discharge. This is driven by voltaic inefficiencies. The significant voltage differences between charging and discharging operating regimes may stress power conversion requirements. For example, in some instances, the swing between charge and discharge may be so large that the lower end of voltage is below the minimum interconnect voltage of an AC/DC inverter connected to common line voltages, and the maximum voltage is above low voltage class limits (e.g., 1500 Vdc).

A ratio of Vₘₐₓ (charging) to Vₘᵢₙ (discharging) over which an electrochemical cell (e.g., a battery) must operate at rated power is a useful proxy for how the electrochemical cell influences power conversion. This ratio is expressed as cell voltage ratio=Vmax/Vmin, and may identify an ideal minimum voltage of a string of cells without knowing absolute cell voltages. That is, the cell voltage ratio may capture the number and scope of reactions for accessible capacity, as well as voltaic inefficiencies without addressing them directly. A fundamental lower bound on the charge/discharge voltage ratio is expected to be limited to approximately 2:1 for an iron-air battery. As a result of practical considerations, however, the charge/discharge voltage ratio of an iron-air battery is generally expected to be higher than 2:1. For example, in the full cycle profile of the iron-air battery shown in FIG. 4, the cell voltage ratio is 3.29.

Operating a DC current limited power conversion system that must maintain a constant operating power over a broad range of DC voltage—that is, over a high cell voltage ratio—generally drives cost proportional to the range of voltage. For example, operating power conversion equipment over larger ranges of voltages is possible, with derating, for a given piece of equipment with a fixed cost and current capability, such as AC line current for AC/DC and battery current for DC/DC. The minimum power available may be proportional to the minimum DC voltage at which the power conversion equipment is operated. When derating systems that are dominated by conduction-losses, a similar amount of loss will be produced at rated current regardless of how much power the device is processing. Operating at lower voltages results in processing less power while producing a similar loss to operation at higher voltages and power, thus efficiency drops. That is, as shown in Table 1 and Table 2 below, while DC voltage range of power conversion equipment may be increased for a given configuration of batteries, such an increase generally comes with an associated increase in price. This, in turn, may limit the commercial viability of achieving required DC voltage ranges required for charging and discharging a given, the given configuration of batteries.

TABLE 1
AC/DC scaling costs as a function of minimum DC voltage.
AC/DC fixed properties

| | |
|---|---|
| AC/DC Cost ($) | 30,000 |
| AC Current Capability (A) | 1000 |

| AC/DC application properties | Configuration 1 | Configuration 2 |
|---|---|---|
| AC Line Voltage (Vrms) | 600 | 208 |
| AC Power Capability (VA) | 1.0E+6 | 360.3E+3 |
| DC Voltage Minimum | 900 | 312 |
| AC/DC Normalized Cost ($/VA) | $0.03/VA | $0.08/VA |
| Efficiency at Rated Power (%) | 97.5% | 92.8% |

TABLE 2
DC/DC scaling costs as a function of minimum DC voltage.
DC/DC fixed properties

| | |
|---|---|
| DC/DC Cost ($) | 8,000 |
| Current Limit (A) | 200 |

| DC/DC application properties | Limit Case 1 | Limit Case 2 |
|---|---|---|
| Minimum DC Voltage (V) | 1500 | 500 |
| Power Capability (W) | 300.0E+3 | 100.0E+3 |
| DC/DC Normalized Cost ($/W) | $0.03/W | $0.08/W |

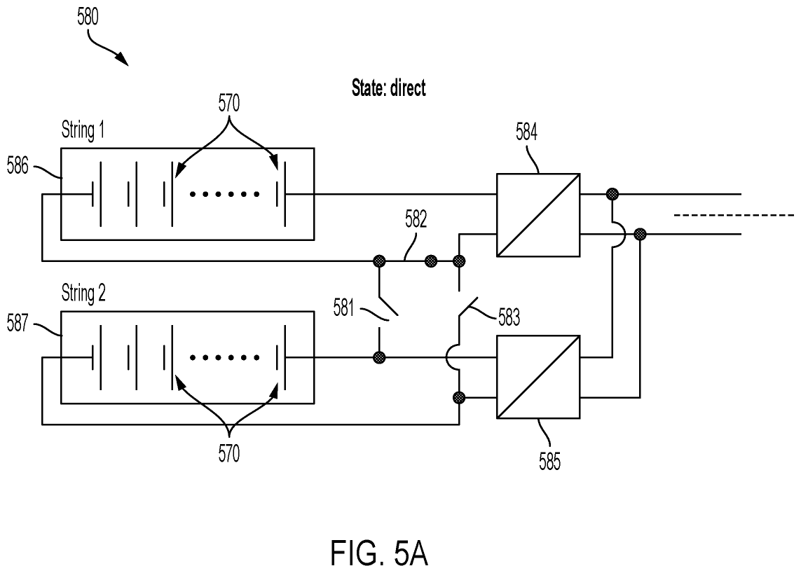

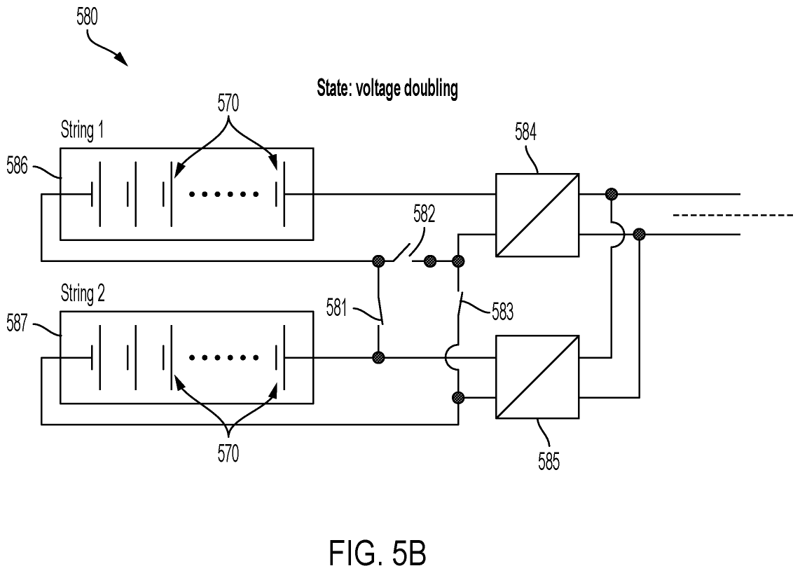

Referring now to FIGS. 5A and 5B, a battery system 580 may provide a dynamic string, referred to herein as a 2S/1S dynamic string, with different electrical configurations depending on the operating-state of the battery system 580. In various implementations, battery strings of the battery system 580 may be created by connected individual cells and modules in series. Additionally, or alternatively, battery strings may be created by connecting individual cells and modules in series such that a maximum operation voltage in charge*the cell S count<VDC max or 1500 V and maximum operational voltage in discharge*2*cell S count<VDC max or 1500 V.

The battery system 580 may include a plurality of batteries 570, a first switch 581, a second switch 582, a third switch 583, a first power converter 584, and a second power converter 585. A first subset of the plurality of batteries 570 may be electrically coupled to one another in a first string 586, and a second subset of the plurality of batteries 570 may be electrically coupled to one another in a second string 587. While the battery system 580 is shown with a first string 586 and a second string 587 of the plurality of batteries 570 and associated switches for changing configurations of the first string 586 and the second string 587, it shall be appreciated that this is for the sake of clear and efficient description and is applicable to any number of strings of batteries as may be required for a given implementation. As described in greater detail below, the battery system 580 may be reconfigurable based on a mode of operation (e.g., charging or discharging) to facilitate cost-effective and efficient power conversion for battery chemistries (e.g., metal-air batteries such as Fe-air batteries) with voltaic inefficiencies that result in a wide voltage range between charge and discharge. That is, as also described in greater detail below, the first switch 581, the second switch 582, and the third switch 583 may be actuated to string more instances of the plurality of batteries 570 in a series configuration during discharge of the plurality of batteries 570 and string fewer instances of the plurality of batteries 570 together in series during charging. As compared to battery configurations without such switching, the dynamically switchable battery configurations of the battery system 580 may reduce the voltage difference between charging and discharging regimes of the batteries in such systems, thus lowering the current voltage ratio (Vₘₐₓ/Vₘᵢₙ) and simplifying criteria for the power conversion equipment used for charging and discharging the plurality of batteries 570.

Referring now to FIG. 5A, the battery system 580 is shown in a configuration for charge, referred to herein as “1S,” with the first switch 581 and the third switch 583 in respective open positions and the second switch 582 is in the closed position. In the 1S configuration, the first power converter 584 and the second power converter 585 may be independently connected to the first string 586 and the second string 587 of the batteries 570, respectively, and may be controlled to operate in lock-step at identical or unique DC currents. Said another way, the first power converter 584 and the second power converter 585 may be independently connected to the first string 586 and the second string 587 of the batteries 570 and may be controlled to operate in lock-step at the same DC currents or the first power converter 584 and the second power converter 585 may be independently connected to the first string 586 and the second string 587 of the batteries 570 may be controlled to operate in lock-step at different DC currents. Maintaining identical or substantially identical charging currents may be effectively the same as charging the first string 586 and the second string 587 of the batteries 570 in series, but this is not strictly necessary. To maintain symmetric power capability of the battery system 580 (that is, the same power capacity in both charge and discharge states), and limit the use of the first power converter 584 and the second power converter 585, the first string 586 and the second string 587 of the batteries 570 may also, or instead, be left disconnected and idle.

Referring now to FIG. 5B, the battery system 580 is shown in a configuration for discharge, referred to herein as “2S,” with the first switch 581 and the third switch in the respective closed positions and the second switch 582 in the open position. In the 2S configuration, the first string 586 and the second string 587 of the batteries 570 are connected in electrical series with each other and with the first power converter 584 and the second power converter 585. To maintain a symmetric power capability of the battery system 580 (with the same power capacity in both charge and discharge states), each of the first string 586 and the second string 587 of the batteries 570 may be used.

Referring again to FIGS. 5A and 5B, the battery system 580 may facilitate operating a DC current-limited power conversion device (e.g., the first power converter 584 and/or the second power converter 585) to operate at the rated power of the DC current-limited power conversion device in both charge and discharge even as cell voltage doubles. As shown in the examples below, various implementations may facilitate using half the number of power conversion stages for a given system with 2S/1S strings compared to the equivalent system design with static strings of electrochemical cells. Additionally, or alternatively, various implementations may facilitate operating electrochemical cells with twice the average power during charge vs. discharge, which may increase the Coulombic efficiency of the electrochemical cell in cases in which low charge currents are hindered by low Coulombic efficiency. In some implementations, a DC/DC or an AC/DC may be used at a point of conversion at the first string 586 or the second string 587 of the batteries 570. In various embodiments, the battery system 580 that is dynamically adjustable between 1S/2S configurations may have a minimum DC voltage that is high enough to allow for string-level DC/AC converters connecting into common interconnection voltages (e.g., 480 Vac), which may facilitate achieving lower cost and/or higher efficiency solutions.

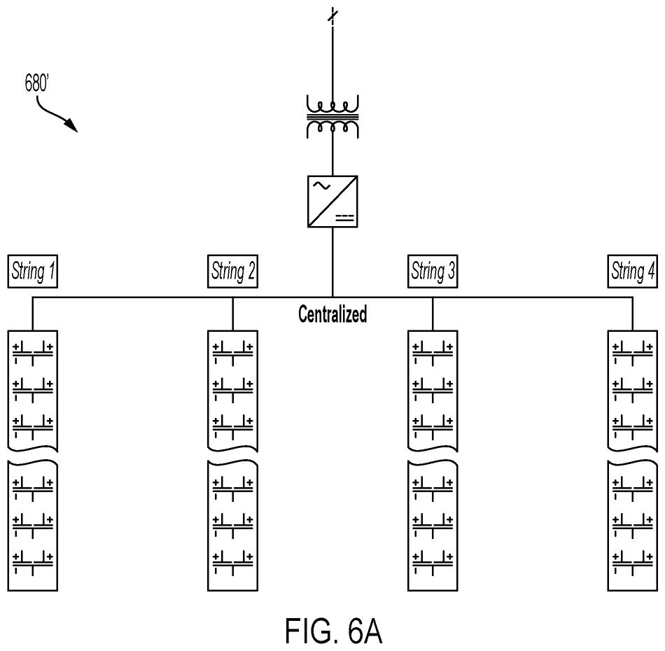

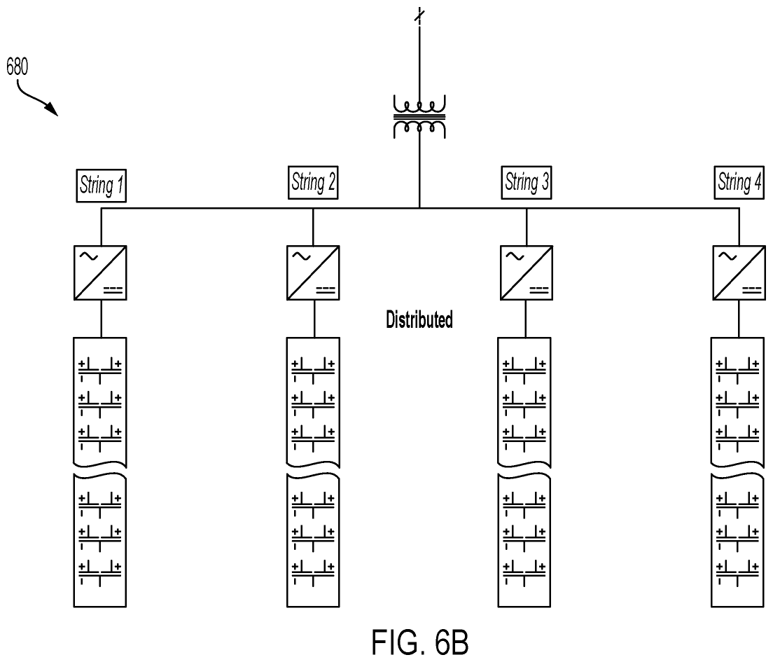

FIGS. 6A and 6B show a comparison of a centralized battery system 680′ and a distributed battery system 680 with respect to the ability to direct power within a block. Many strings of batteries in parallel share current as a function of state-of-charge (SOC) and capacity/state-of-health (SOH) and additionally, or alternatively, may be influenced by service. Strings of batteries with a distributed and dedicated power conversion stage (FIG. 6B) may be individually controlled. For example, each string of batteries may be turned on or off based on power block load. Further, or instead, each string of batteries may be held at different SOC. Still further, or instead, strings of batteries with differing SOH may be forced to contribute equal power.

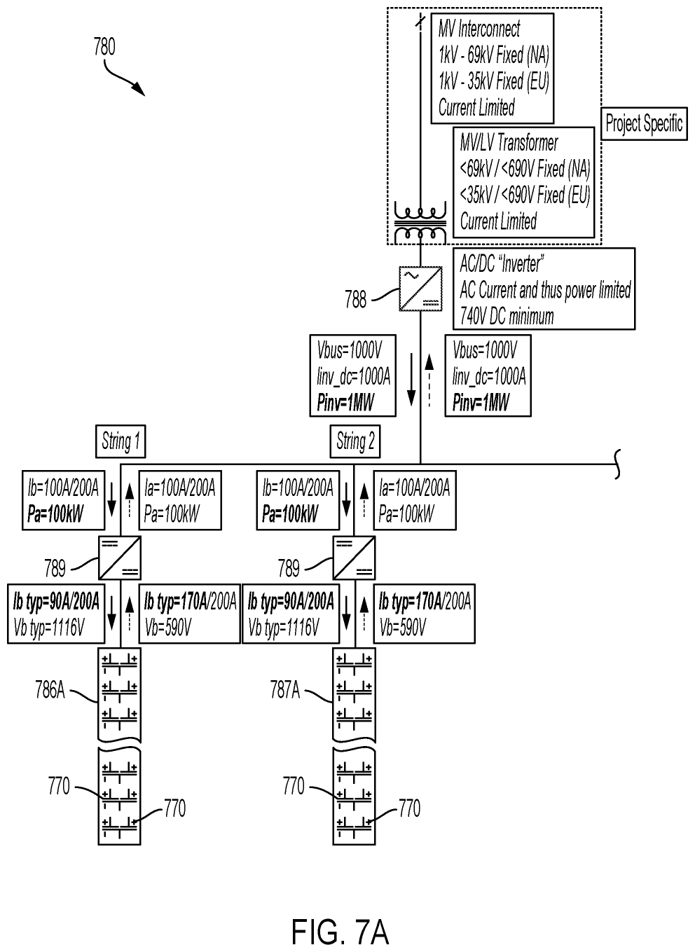

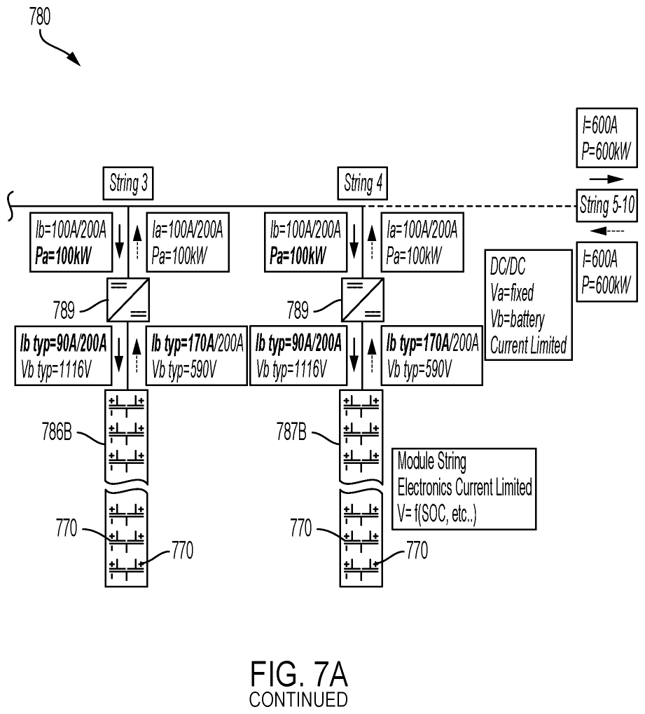

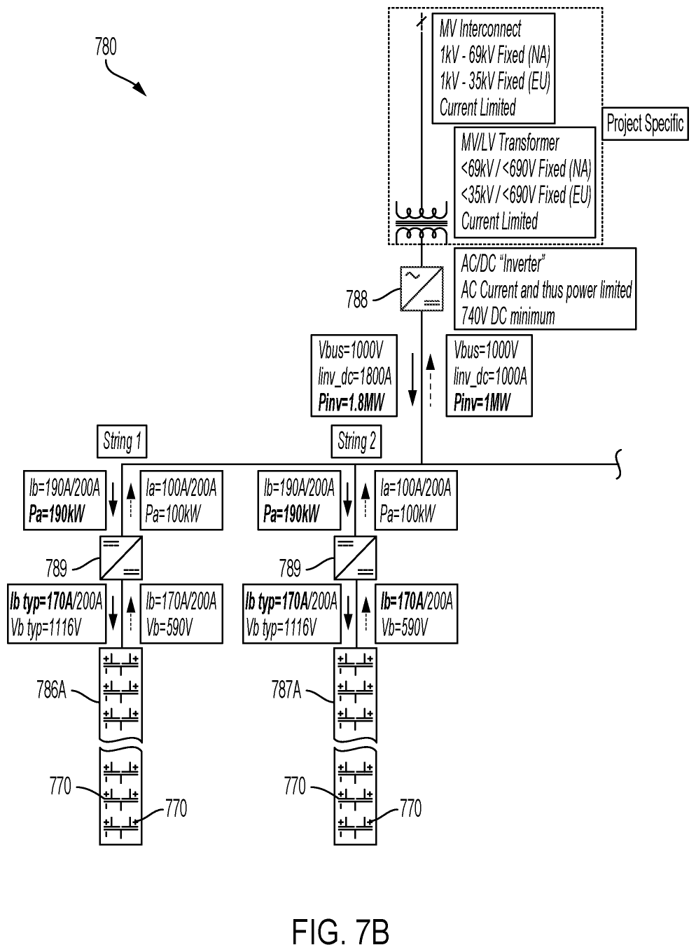

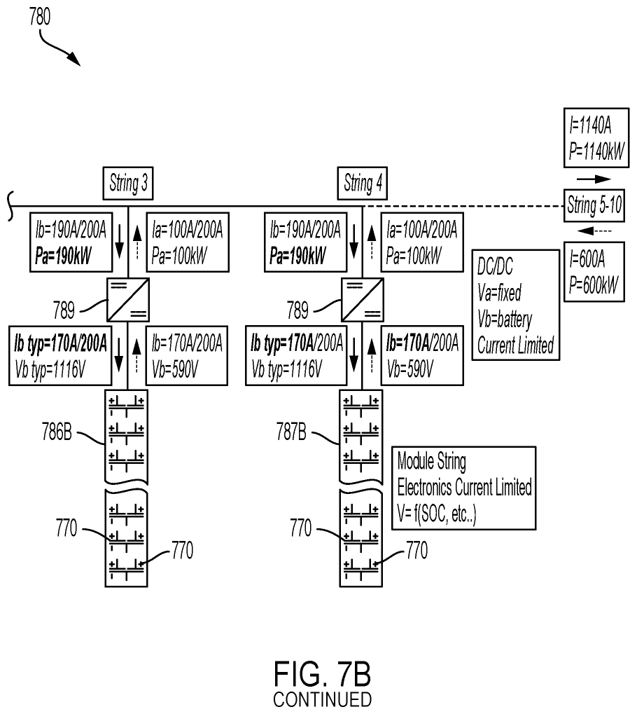

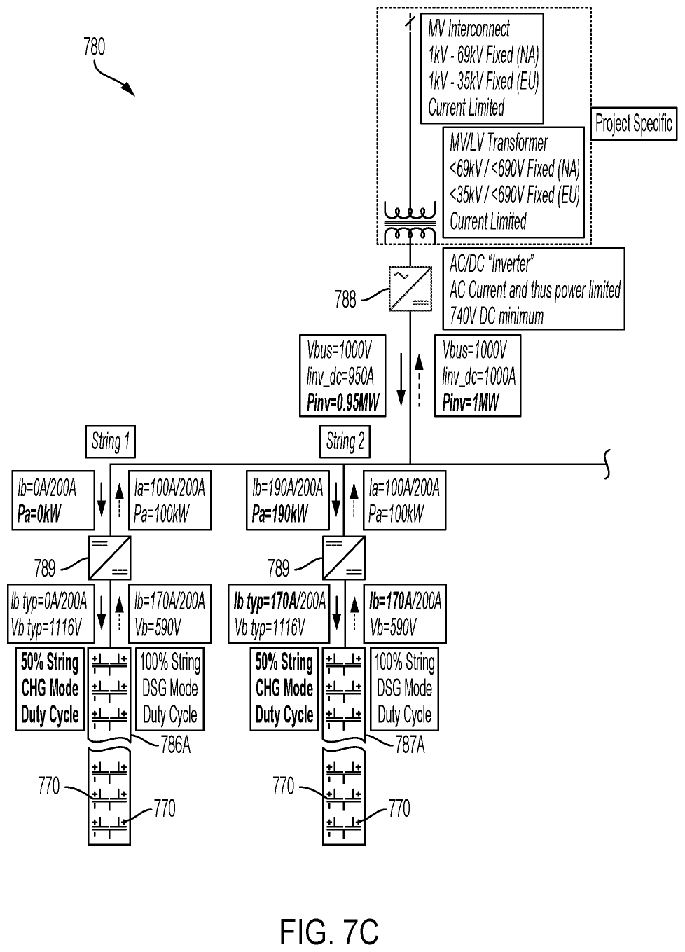

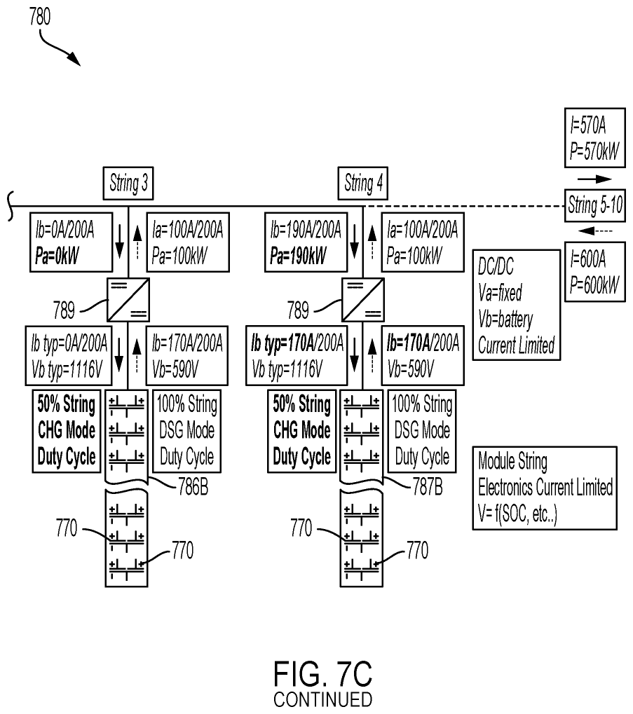

Referring now to FIGS. 7A-7C, a first baseline configuration of a battery system 780 may include a plurality of batteries 770, a centralized AC/DC inverter 788, a plurality of string DC/DC converters 789. The plurality of batteries 770 may be arranged as a first string 786A, a second string 787A, a third string 786B, and a fourth string 787B. The first baseline configuration of the battery system 780 may be operated in symmetric power (SP) operation mode (FIG. 7A), in symmetric typical current (STC) operation mode (FIG. 7B), and in staggered symmetric typical current (SSTC) operation mode (FIG. 7C) is shown below in Table 3. With two points of conversion and moderate DC power derating, the battery system 780 has a low efficiency and is costly compared to other battery system configurations described below.

TABLE 3
Operation of the battery system 780 in different operating modes.

| | | SP | STC | SSTC |
|---|---|---|---|---|
| Discharge Power | MW | 1 | 1 | 1 |
| Charge Power | MW | 1 | 1.89 | 0.95 |
| Current Ratio | A/A | 0.53 | 1 | 1 |
| (Chg/Dch) | | | | |
| Duration Ratio | h/h | 2.38 | 1.26 | 2.52 |
| (Chg/Dch) | | | | |

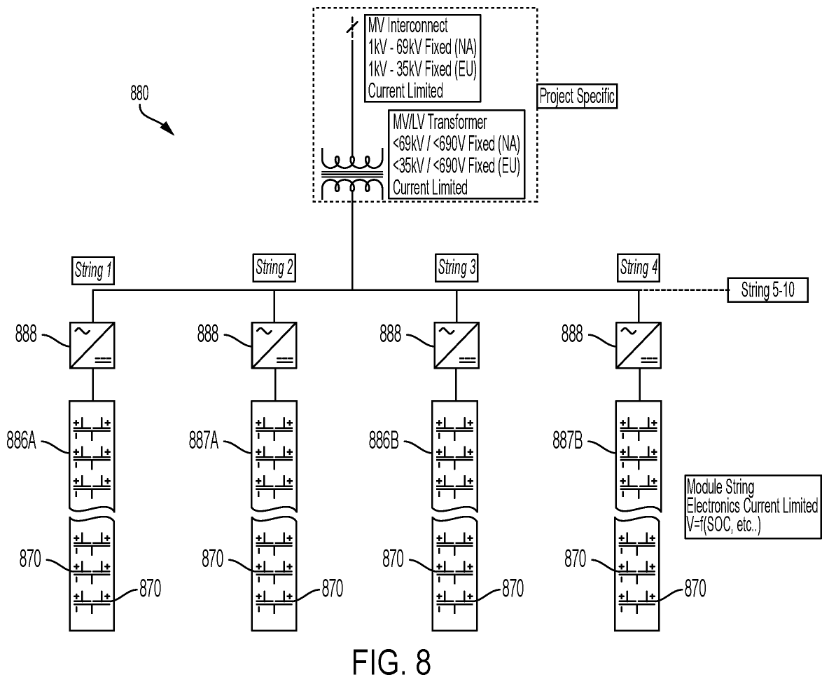

Referring now to FIG. 8, a second baseline configuration of a battery system 880 may include a plurality of batteries 870 and a plurality of string AC/DC inverters 888. The plurality of batteries 870 may be arranged as a first string 886A, a second string 887A, a third string 886B, and a fourth string 887B. Each one of the plurality of string AC/DC inverters 888 may be coupled in series with a respective instance of the first string 886A, the second string 887A, the third string 886B, and the fourth string 887B. The second baseline configuration of the battery system 880 may be operated in a symmetric power (SP) operating mode, in a symmetric typical current (STC) operating mode, and in a staggered symmetric typical current (SSTC) operating mode. As compared to configurations described below, the second baseline configuration of the battery system 880 requires a low AC line voltage, which is associated with significant derating and requires additional cost. Further, as compared to configurations described below, the second baseline configuration of the battery system 880 has a single point of conversion, but with significant derating that adversely impacts efficiency. Additionally, the second baseline configuration of the battery system 880 may be without derated capability at low string voltages, requiring an external startup circuit.

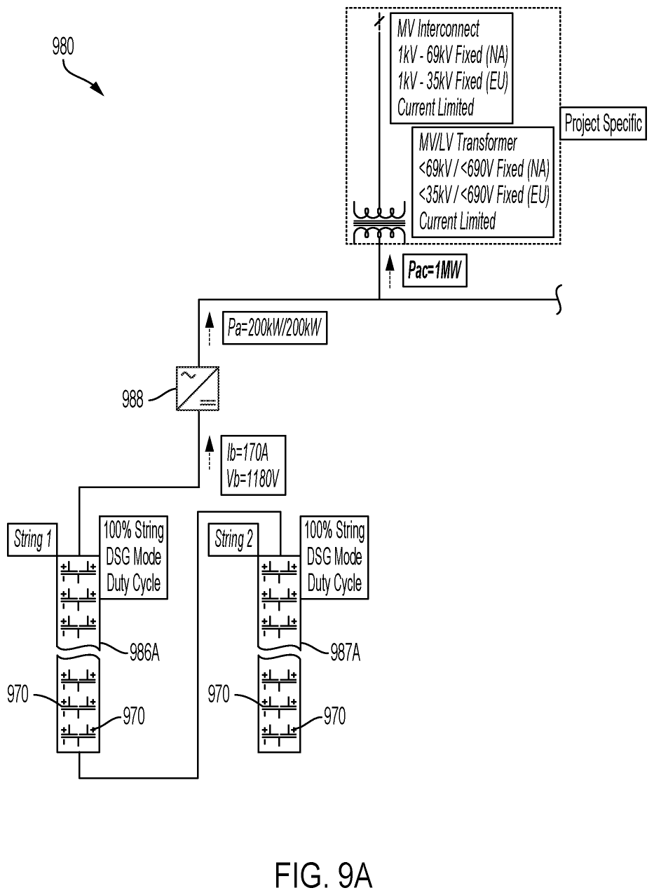

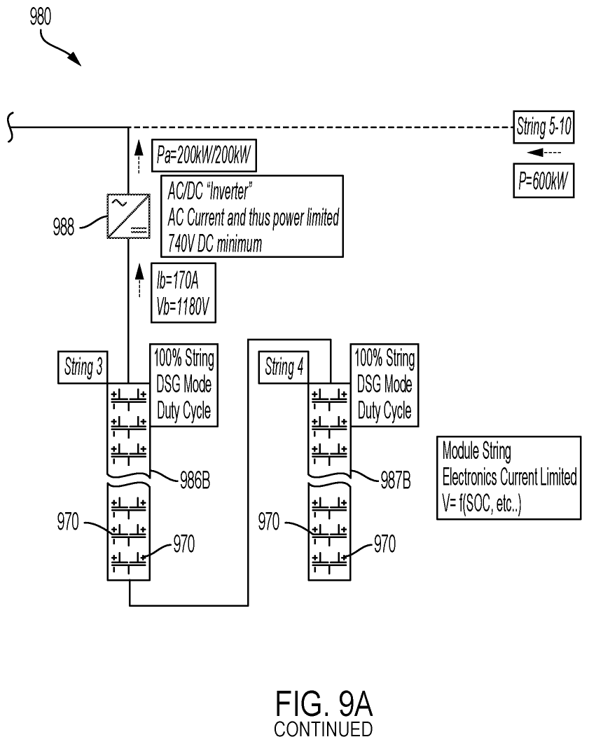

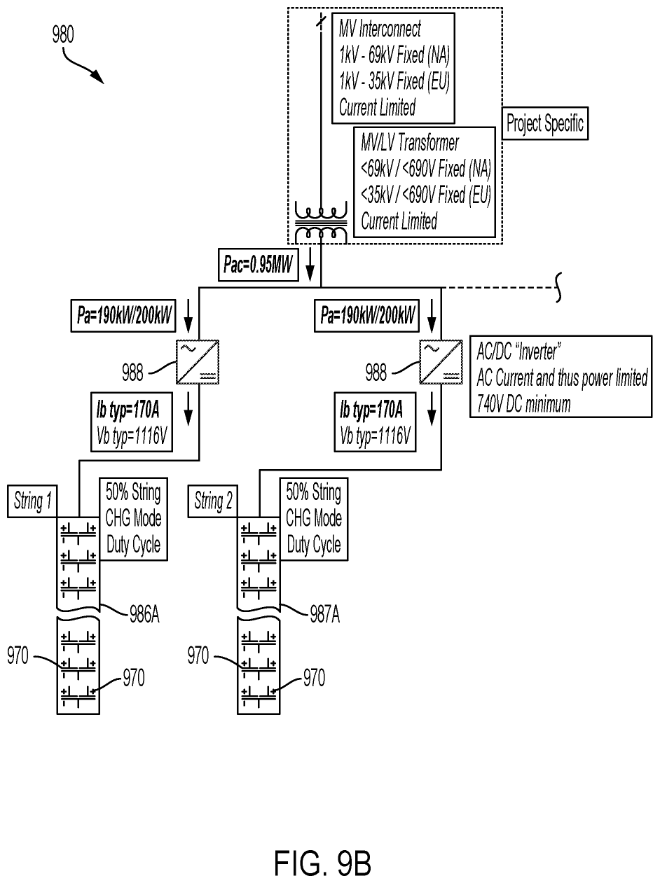

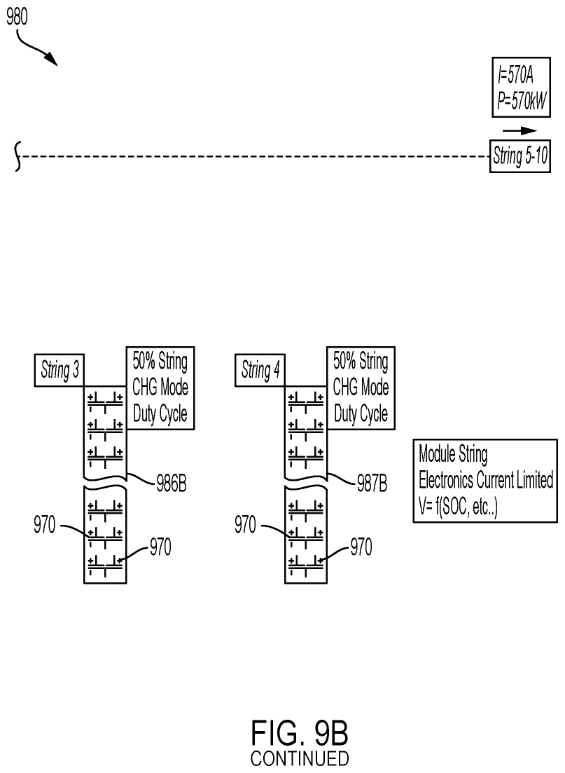

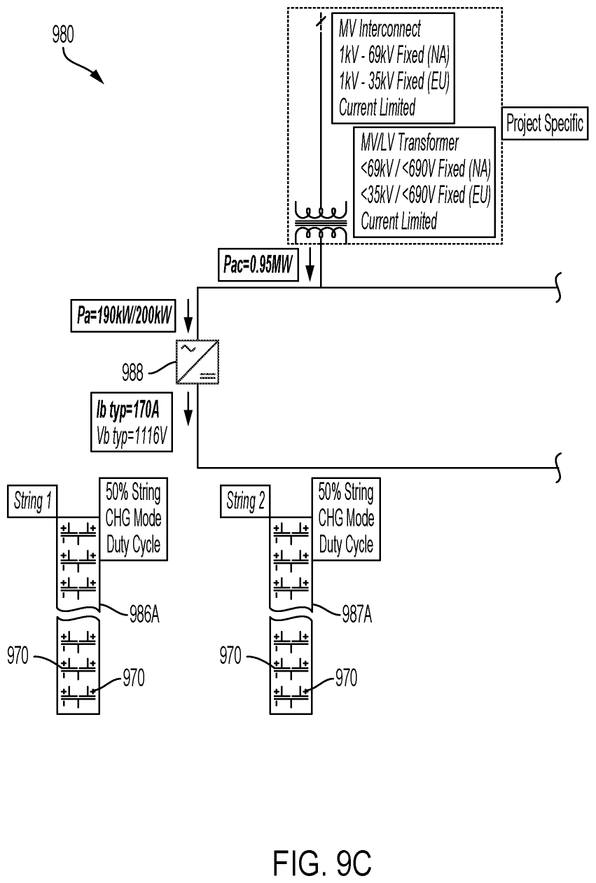

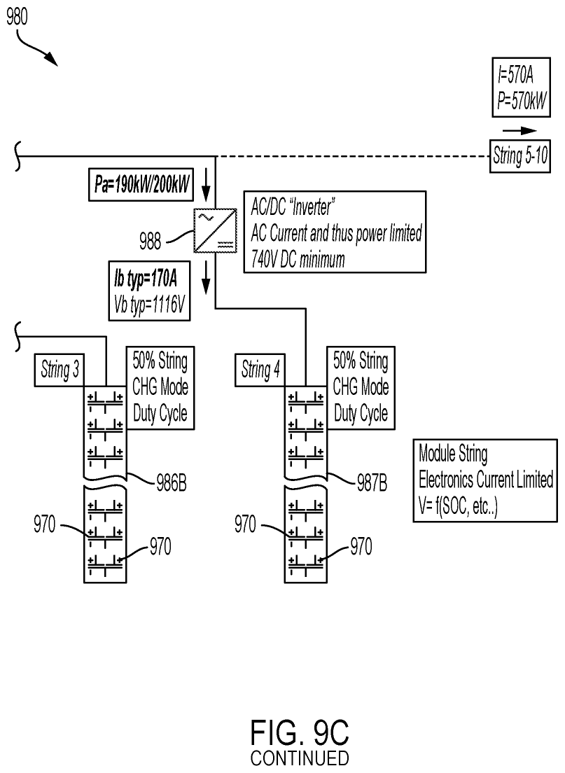

Referring now to FIGS. 9A-9C, a battery system 980 may include a plurality of batteries 970 and a plurality of string AC/DC inverters 988. The plurality of batteries 970 may be arranged as a first string 986A, a second string 987A, a third string 986B, and a fourth string 987B. Electrical communication between the plurality of string AC/DC inverters 988 may be switched between the first string 986A, the second string 987A, the third string 986B, and the fourth string 987B to switch the battery system 980 switchable between direct state (1S) and voltage doubling (2S) configurations.

The battery system 980 is operable in staggered symmetric typical current (SSTC). As compared to the first baseline configuration of the battery system 780 (FIGS. 7A-7C) and to the second baseline configuration of the battery system 880 (FIG. 8), the battery system 980 may be less expensive—requiring half the number of string-level power converters, with some added cost of switching. Further, or instead, the battery system 980 has a single point of conversion with minimal DC power derating, cutting the effective voltage ratio in half. For at least these reasons, the battery system 980 may be much more efficient than the first baseline configuration of the battery system 780 (FIGS. 7A-7C) and/or the second baseline configuration of the battery system 880 (FIG. 8). The battery system 980 may have no derated capability at low string voltages (requiring an external startup circuit), and the 2S/1S voltage doubling may have some associated complexity.

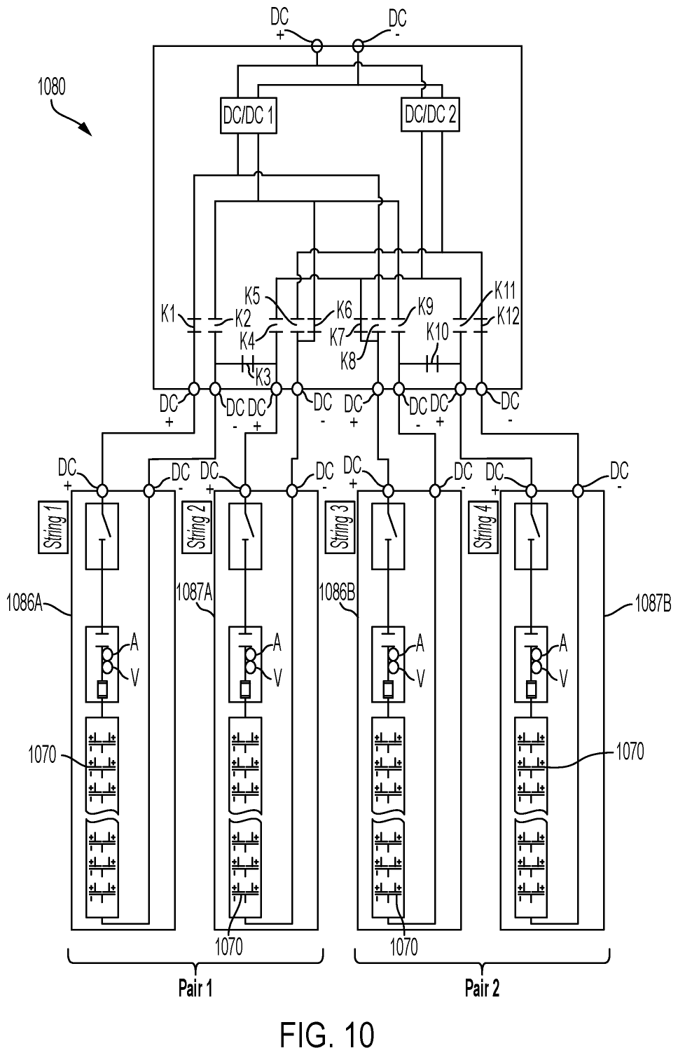

Referring now to FIGS. 10, a battery system 1080 may include a plurality of batteries 1070 and a plurality of contacts K1, K2, K3, K4, K5, K6, K7, K8, K9, K10, K11, and K12. The plurality of batteries 1070 may be arranged as a first string 1086A, a second string 1087A, a third string 1086B, and a fourth string 1087B. As shown in Table 4, the states of the plurality of contacts K1, K2, K3, K4, K5, K6, K7, K8, K9, K10, K11, and K12 may be switched to change the battery system 1080 between a discharge state, a first charge state, and a second charge state as required for operation of the plurality of batteries 1070. In certain instances, several contacts (e.g., K3+K6, K7+K10, K4+K5, and K8+K9) may be combined into multi-pole contacts or switches, and the remaining contacts may be single-pole contacts or switches.

TABLE 4
States of contactor switches for switching between a discharge
state, a first charge state, and a second charge state.

| Contact State | | | | |
|---|---|---|---|---|
| Mapping | Discharge | Charge 1 | Charge 2 | Notes |
| K1 (Str 1+ | Closed | Closed | | <closed in |
| to DC/DC 1+) | | | | multiple states, |
| | | | | must be single |
| | | | | pole |
| K2 (Str 1+ | | Closed | | |
| to DC/DC 1−) | | | | |
| K3 (Str 1− | Closed | | | |
| to Str 2+) | | | | |
| K4 (Str 2+ | | Closed | | |
| to DC/DC 2+) | | | | |
| K5 (Str 2− | | Closed | | |
| to DC/DC 2−) | | | | |
| K6 (Str 2− | Closed | | | |
| to DC/DC 1−) | | | | |
| K7 (Str 3+ | Closed | | | |
| to DC/DC 2+) | | | | |
| K8 (Str 3+ | | | Closed | |
| to DC/DC+) | | | | |
| K9 (Str 3− | | | Closed | |
| to DC/DC 1−) | | | | |
| K10 (Str 3− | Closed | | | |
| to Str 4+) | | | | |
| K11 (Str 4+ | | | Closed | |
| to DC/DC 2+) | | | | |
| K12 (Str 4− | Closed | | Closed | <closed in |
| to DC/DC 2−) | | | | multiple states, |
| | | | | must be single |
| | | | | pole |

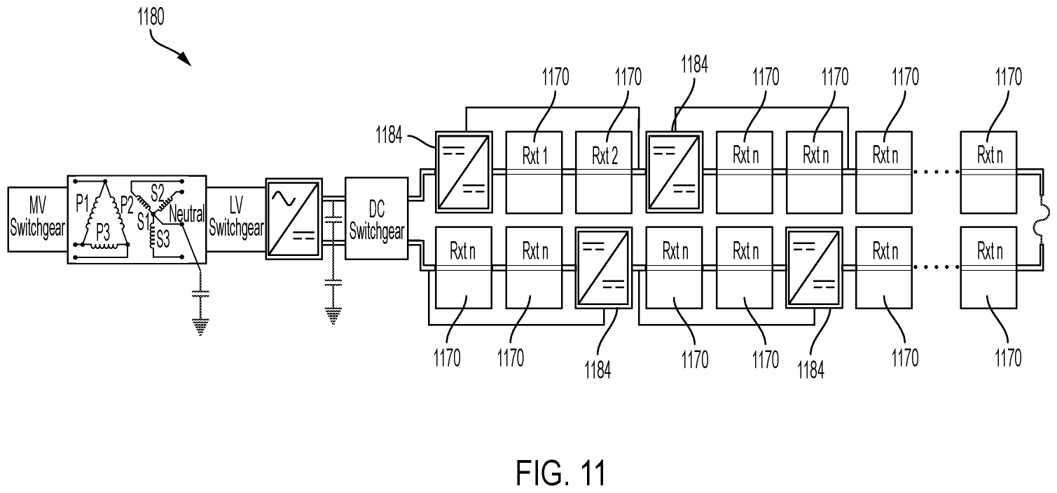

Referring now to FIG. 11, a battery system 1180 may include a plurality of batteries 1170 substring and a plurality of DC/DC power converters 1184. As an alternative to serially stringing reactors to achieve a target DC voltage, the plurality of DC/DC power converters 1184 may be used to step-up bus voltage of individual instances of the plurality of batteries 1170 and/or a subset of the plurality of batteries 1170. In certain instances, subsets of the plurality of batteries 1170 may be optimized for power output and may match voltages across strings of the plurality of batteries 1170. As an example, output from individual instances of the plurality of batteries 1170 may be DC/DC converted to a common DC voltage bus used to collect current from the other instances of the plurality of batteries 1170. Additionally, or alternatively, substrings of the plurality of batteries 1170 may be connected in parallel to a common DC bus. As another example, several instances of the plurality of batteries 1170 may be serially connected within a substring and stepped-up with a DC/DC converter to a common DC bus voltage. Further, or instead, substrings of the plurality of batteries 1170 may be DC/DC converted (boost/buck) and connected serially to achieve a regulated DC bus voltage as shown in FIG. 11. Still further, or in the alternative, the DC voltage range at the input of an inverter may be minimized which, in turn, may reduce complexity and cost.

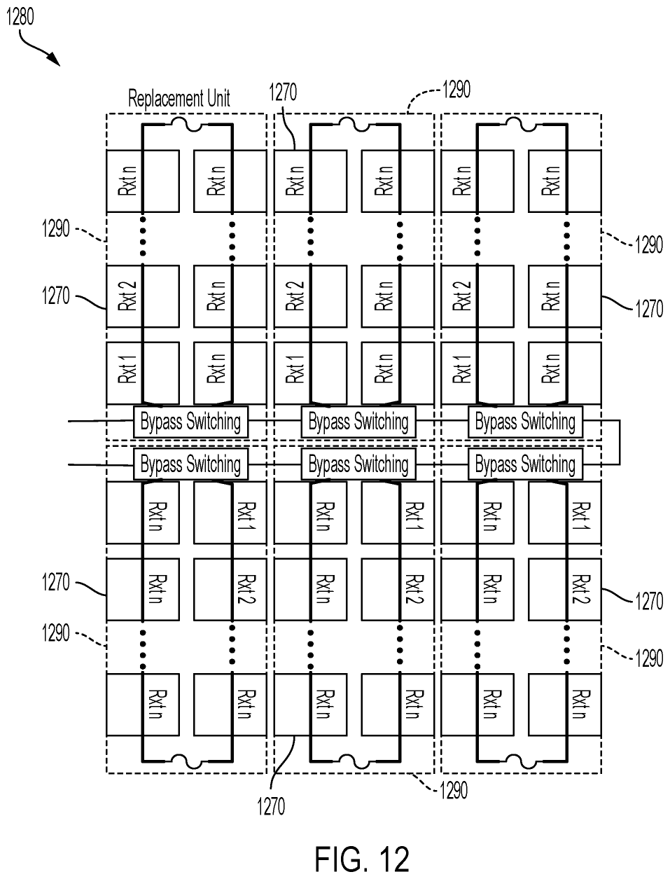

Referring now to FIG. 12, a battery system 1280 may include a plurality of batteries 1270 electrically coupled to one another with short-edge field unit electrical bypassing. The plurality of batteries 1270 may be grouped into substrings 1290 that are electrically isolatable from one another using bypass switching circuitry. When using a bypass function, the full string current is still present within the bypass circuit. Accordingly, it may be generally advantageous to minimize the path to reduce the loss burden and hardware cost of the bypass circuit. The substrings 1290 may be oriented such that the respective internal current path of each substring 1290 forms a U-shape where the given instance of the substring 1290 starts and ends on the same side. Further, or instead, the mechanical structure may be made such that the current connection side is short relative to the other dimensions of the respective instance of the substring 1290 (i.e., narrow aspect ratio). This may facilitate bypassing using a shorter path, as compared to bypassing required in instances in which strings are arranged in an “I” formation along the longer dimension of the string. Further, or instead, the battery system 1280 may include switching functionality such that the substrings 1290 may be switched into and out of the battery system 1280 to perform capacity matching. The switching functionality may further, or instead, provide a mechanism for voltage compensation, as may be useful for minimizing the DC input range of an inverter. Additionally, or alternatively, the switching functionality of the battery system 1280 may facilitate providing redundancy in the vent of a critical failure within a given instances of the substring 1290 or an auxiliary system associated with the given instance of the substring 1290. Still further, or in the alternative, the switching functionality of the battery system 1280 may facilitate pre-assembling portions of the battery system 1280 such that the substrings 1290 may be hot-swapped with little or no disruption in operation of the battery system 1280.

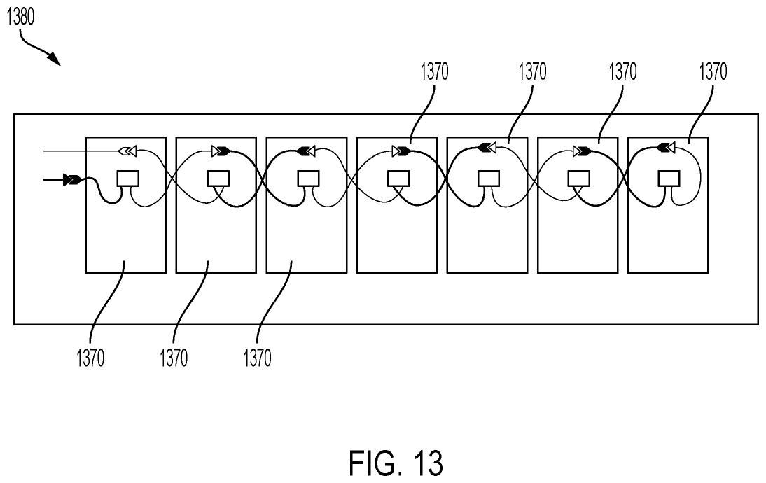

Referring now to FIG. 13, a battery system 1380 may include a plurality of batteries 1370 that are electrically coupled to one another in series using skip stringing. As used in this context, “skip stringing” shall be understood to refer to a technique of electrically coupling the batteries 1370 without the use of a homerun cable providing a return for current from the farthest point in a string. In skip stringing the plurality of batteries 1370, every other instance of the batteries 1370 may be connected to the string both down the length of the plurality of batteries 1370 and in the return path. As compared to the use of a homerun cable, skip stringing the plurality of batteries 1370 to one another may facilitate using modular cables, which may reduce cost and/or reduce cable power losses.

Various embodiments may provide inter-module electrical stringing configurations and controls for metal-air battery systems. For example, inter-module electrical stringing configurations between modules comprised of multiple batteries (e.g., multiple batteries 200).

Metal-air batteries may be connected in electrical networks to combine the power output from individual battery modules (each of which consist of a number of cells). These networks may include a combination of serial and parallel connections to incrementally step up the voltage and current, respectively. The configurations and stringing approaches must be designed to minimize cost and loss. Various embodiments of electrical stringing configurations and controls pertaining to inter-module connections are discussed herein.

Various embodiments may use DC/DC converters to step-up battery string voltage to a common bus voltage. DC/DC converters may be used to step-up the bus voltage of individual battery modules or a string of battery modules. This enables modules or strings of modules to be individually optimized for power output despite differences in string properties such as age, impedance, state of charge, and voltage. Several possible embodiments are described below.

The foregoing method descriptions and the process flow diagrams are provided merely as illustrative examples and are not intended to require or imply that the steps of various embodiments should be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular. Herein, “about” may refer to a range of +/−5%.

Further, any step of any embodiment described herein can be used in any other embodiment. The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A battery system, comprising:
two or more strings of batteries; and
an electrical power conversion system connected to the strings of batteries and controllable to change configuration of connections of a set of switches to the two or more strings based on an operating state of the battery system.

2. The battery system of claim 1, wherein each of the strings of batteries comprise battery cells connected in series.

3. The battery system of claim 2, wherein the battery cells are connected in series to have:
a maximum operational voltage in a charge operating state less than a DC voltage maximum; and
a maximum operational voltage in a discharge operating state less than the DC voltage maximum.

4. The battery system of claim 3, wherein the DC voltage maximum is 1500 V.

5. The battery system of claim 1, wherein the two or more strings of batteries comprise metal-air type battery cells.

6. The battery system of claim 5, wherein the metal-air type battery cells comprise iron-air type battery cells, zinc-air type battery cells, and/or lithium-air battery cells.

7. The battery system of claim 1, wherein:
the two or more strings of batteries comprise at least a four string grouping;
in a charge state:
in a first charging configuration the electrical power conversion system connects two power conversion stages independently to two strings of batteries of the four string grouping and controls the two power conversion stages to operate in lock-step at identical or unique DC currents to charge the two strings of batteries of the four string grouping; and
in a second charging configuration the electrical power conversion system connects the two power conversion stages independently to the other two strings of batteries of the four string grouping and controls the two power conversion stages to operate in lock-step at identical or unique DC currents to charge the other two strings of batteries of the four string grouping; and
in a discharge state:
a first set of two strings of batteries of the four string grouping is connected in series;
a second set of the two strings of batteries of the four string grouping is connected in series; and
the electrical power conversion system connects one of the two power conversion stages to the first set of two strings and the second of the two power conversion stages to the second set of two strings.

8. The battery system of claim 1, further comprising:
a) DC/DC converters configured to step-up module voltage to a common bus voltage; and/or
b) subsets of serially connected substrings of battery modules, wherein the subsets are configured to be connected into a full string; and
a bypass switch associated with each subset configured to enable each subset to be individually switched in and out of the full string; and/or
c) a series of modules connected via skip stringing.

9. A battery system, comprising:
subsets of serially connected substrings of modules, wherein the subsets are configured to be connected into a full string; and
a bypass switch associated with each subset configured to enable each subset to be individually switched in and out of the full string.

10. A battery system, comprising:
a series of battery modules connected via skip stringing.

11. The battery system of claim 10, wherein the battery modules comprise metal-air type battery cells.

12. The battery system of claim 11, wherein the metal-air type battery cells comprise iron-air type battery cells, zinc-air type battery cells, and/or lithium-air battery cells.

13. A battery system, comprising:
a) DC/DC converters configured to step-up module voltage to a common bus voltage; and/or
b) subsets of serially connected substrings of modules, wherein the subsets are configured to be connected into a full string; and
a bypass switch associated with each subset configured to enable each subset to be individually switched in and out of the full string; and/or
c) a series of modules connected via skip stringing.
